(19) United States
(12) Patent Application Publication
(10) Pub. No.: US 2006/0267954 A1
(43) Pub. Date: Nov. 30, 2006

(54) Information processing system and recording medium used for presentations

(75) Inventors: Katsuhiko Akiyama, Kawasaki (JP); Hiroshi Tanaka, Kawasaki (JP)

Correspondence Address: ARENT FOX PLLC, 1050 CONNECTICUT AVENUE, N.W., SUITE 400, WASHINGTON, DC, 20036, US

(73) Assignee: Fujitsu Limited

(21) Appl. No.: 11/213,873

(22) Filed: Aug. 30, 2005

(30) Foreign Application Priority Data
May 26, 2005 (JP) 2005-154392

(51) Int. Cl. G09G 5/00

(52) U.S. Cl. 345/173

(57) ABSTRACT

An information processing system that is connected to a display apparatus and to an input apparatus includes: a material display part that displays a material used for a presentation in the form of an image on the display apparatus; an input part that inputs and accumulates as an indication mark a sequence of consecutively inputted pieces of position information inputted from the input apparatus; an indication mark display part that displays the indication mark together with the material on the display apparatus in one of at least two different display modes; and a display mode control part that controls the display mode of the indication mark based on information inputted from the input apparatus.

### BACKGROUND OF THE INVENTION

1. Field of the Invention

The present invention relates to an information processing system and a recording medium that are used to make a presentation using a display apparatus controlled by a computer.

2. Description of Related Art

In a demonstration, a research presentation or the like at various conferences, demonstration materials are displayed on a large-screen display, a screen or the like and used to perform a demonstration, namely, a so-called presentation. In a presentation, a demonstrator performs a demonstration while indicating an image displayed on a screen.

Before computers were brought into wide use, overhead projectors (hereinafter, referred to as an OHP) and the like had been used commonly. Recent years have seen many cases where a program for a presentation is operated on a computer and an image produced by the computer is projected on a large screen by a projector.

When making a presentation, for a demonstration, a demonstrator points a pointing stick, a laser pointer or the like at a point (point of interest) to which the attention of an audience should be directed. In the case of using an OHP, as has been the case conventionally, a demonstrator may make a shadow by putting a pen, a stick or the like on a material so as to indicate a point of interest.

In the case where a demonstrator indicates a point of interest using a pointing stick or a laser pointer, the point being indicated is displayed in the form of a spot and wobbles unstably due to vibration of hands. This has been a hindrance to accurately and clearly indicating a point of interest using a pointing stick or a laser pointer. Further, shadowing a point of interest by disposing an object on an OHP has presented a problem that the point of interest is indicated unclearly to an audience.

On the other hand, in a presentation using a computer, a point of interest can be indicated clearly. In order to indicate a point of interest, for example, a mouse pointer is pointed at the point of interest, or alternatively, the point of interest on a material is marked by handwriting using a tablet and a stylus.

FIG. 21(A) is a diagram showing an example of a configuration of equipment for making a presentation using a computer. In the example shown in FIG. 21(A), a computer 83 is connected to a projector 85 and to a coordinate input apparatus 84. The computer 83 outputs a material to be used for a demonstration to the projector 85. The projector 85 displays the material on a screen 82. Using the coordinate input apparatus 84, a demonstrator inputs coordinates on a view displayed on the screen 82. This allows a point of interest in the displayed material to be indicated. The coordinate input apparatus 84 includes a tablet 84a and a stylus 84b.

FIG. 21(B) shows an example of a screen on which a point of interest is indicated by a mark written on a view outputted by the computer 83. In this example, “Comment 1” is underlined and “Item 2” is marked with a circle. “Comment 1” and “Item 2” are indicated as points to which the attention of an audience should be directed. Hereinafter, such a mark for indicating a point of interest will be referred to as an indication mark.

FIG. 22 is a functional block diagram showing a configuration of the computer 83 shown in FIG. 21(A). By a demonstration material display part 92, information regarding a material to be displayed in a presentation is outputted in the form of an image to the projector 85. Coordinate values inputted consecutively by means of the coordinate input apparatus 84 are accumulated in an indication mark storing part 94 as indication mark information that represents an indication mark. By an indication mark display part 93, the indication mark information accumulated in the indication mark storing part 94 is displayed in such a manner as to be superimposed on the demonstration material to be displayed by the projector 85.

In a presentation using the above-described computer 83, when a plurality of indication marks are displayed on a display screen, an audience hardly can distinguish a point of interest being indicated currently, which is disadvantageous. That is, as a demonstration progresses, the number of indication marks displayed on a screen increases, so that it becomes difficult for an audience to distinguish an indication mark to which their attention should be directed currently. With a larger number of indication marks, the numerous indication marks are displayed on a demonstration material, so that the visibility of the demonstration material also is impaired.

As disclosed in, for example, JP 6(1994)-175776 A, a presentation system has been proposed to solve these problems. In this conventional presentation system, when a new indication mark is inputted, indication marks that have been inputted previously are erased and only the indication mark inputted last is displayed. Therefore, only one indication mark is displayed at any time, which allows an audience to distinguish a point to which their attention should be directed with less difficulty.

### SUMMARY OF THE INVENTION

However, in the above-described conventional presentation system, since indication marks other than a newest indication mark are erased automatically, a problem may occur. No problem occurs, for example, in the case where points on a material are indicated in succession with only one point of interest being indicated, which is the newest. However, in the case where, in a demonstration, a demonstrator refers to points back and forth or indicates a plurality of points at the same time, since a plurality of indication marks that have been inputted previously are no longer displayed, the demonstrator is hindered from effectively using an indication mark.

For example, as in the screen shown in FIG. 21(B), two indication marks written with respect to “Comment 1” and “Item 2”, respectively, are displayed, making it easier to relate “Comment 1” to “Item 2” in a demonstration. However, in a configuration in which indication marks other than a newest indication mark are not displayed, such a demonstration hardly can be performed.

As described above, the conventional presentation system has presented a problem that the effective use of an indication mark in a presentation often is hindered.

Therefore, with the foregoing in mind, it is an object of the present invention to provide an information processing system that enables a presentation in which an indication mark is used effectively.

An information processing system according to the present invention is an information processing system that is connected to a display apparatus and to an input apparatus so as to be used for a presentation. The system includes: a material display part that displays information regarding a material used for the presentation in the form of an image on the display apparatus; an input part that inputs as an indication mark a sequence of consecutively inputted pieces of position information among information inputted from the input apparatus; an indication mark storing part that accumulates the indication mark inputted at the input part; a display attribute storing part in which display attributes that respectively represent at least two different display modes of the indication mark are accumulated beforehand; an indication mark display part that displays the indication mark accumulated in the indication mark storing part together with the material on the display apparatus in one of the display modes represented respectively by the groups of display attributes accumulated in the display attribute storing part; and a display mode control part that controls the display mode of the indication mark based on the information inputted from the input apparatus.

In the information processing system according to the present invention, the display attribute storing part accumulates control information beforehand, which is an accumulation of groups of display attributes corresponding respectively to displays in at least two different display modes, and thus an indication mark inputted at the input part is displayed in one of the two or more different display modes. Since the display modes are controlled by the display mode control part based on information inputted from the input apparatus, a demonstrator can designate a display mode of an indication mark by inputting position information or control information by means of the input apparatus. That is, the demonstrator can control display modes of an indication mark so as to facilitate his/her convenience. As a result, the demonstrator can perform a demonstration using an indication mark effectively on an image displayed by the information processing system.

A recording medium according to the present invention is a recording medium on which a program that allows a computer to perform processing is recorded. The computer is connected to a display apparatus and to an input apparatus. The processing includes processes of displaying information regarding a material used for a presentation in the form of an image on the display apparatus; inputting as an indication mark a sequence of consecutively inputted pieces of position information among information inputted from the input apparatus and accumulating the indication mark in a storing unit; displaying the indication mark accumulated in the storing unit together with the material on the display apparatus based on one of display attributes that are accumulated beforehand in the storing unit and respectively represent at least two different display modes of the indication mark; and controlling the display mode of the indication mark based on the information inputted from the input apparatus.

According to the present invention, an information processing system and a recording medium that enable a presentation in which an indication mark is used effectively.

### BRIEF DESCRIPTION OF THE DRAWINGS

FIGS. 1(A) and 1(B) are diagrams that conceptually show examples of a configuration of equipment when an information processing system is used.

FIG. 2 is a functional block diagram showing an internal configuration of an information processing system 1.

FIG. 3 is a diagram showing an example of a data structure of indication mark information that is stored in an indication mark storing part 8.

FIG. 4 is a diagram conceptually showing an example of a data structure of display attributes that are stored in a display attribute storing part 12.

FIG. 5(A) is a diagram showing an example of a screen display immediately after an indication mark is inputted by means of a tablet apparatus 4. FIG. 5(B) is a diagram showing an example of a screen display resulting from an indication mark display (step S53). FIG. 5(C) is a diagram showing an example of a screen when all indication marks are displayed in a non-interest mode.

FIG. 6 is a flow chart showing a flow of processes performed by the information processing system 1 in a presentation.

FIG. 7(A) is a flow chart showing an example of a new indication mark input process. FIG. 7(B) is a flow chart showing an example of a position selecting process.

FIGS. 8(A), 8(B), 8(C) and 8(D) are diagrams that show examples of screen displays realized by operations in the information processing system 1, which are shown in FIGS. 6 and 7, respectively.

FIGS. 9(A) and 9(B) show examples of a screen display when an indication mark is selected through a selection among buttons provided at a lower portion of a screen.

FIG. 10 is a diagram showing an example of a data structure of display attributes that are stored in the display attribute storing part 12.

FIGs. 11(A), 11(B), 11(C) and 11(D) are diagrams that show examples of screen displays when there are three types of states that are a selected state, a non-selected state and an invisible state.

FIG. 12 is a diagram showing an example of a data structure of display attributes that are stored in the display attribute storing part 12.

FIG. 13 is a diagram showing a flow of processes in the case where after an indication mark is newly inputted, another indication mark is selected.

FIG. 14 shows a transition of a screen display in the case where after an indication mark is newly inputted, another indication mark is selected.

FIG. 15 is a functional block diagram showing a configuration of an information processing system 10.

FIG. 16(A) is a diagram showing an example of a data structure of indication mark information that is stored in an indication mark storing part 8. FIG. 16(B) is a diagram showing an example of a data structure when indication mark information is stored at the indication mark storing part 8 so as to correspond to a group.

FIG. 17 is a flow chart showing an example of processes in which when inputted, a new indication mark is stored by an input part 17 so as to correspond to a group.

FIG. 18 is a flow chart showing a flow of processes in which an indication mark identifying part 13 identifies an indication mark.

FIG. 19 is a diagram showing an example of an interest mode for an enclosing indication mark.

FIG. 20 is a functional block diagram showing a configuration of an information processing system 20.

FIG. 21(A) is a diagram showing an example of a configuration of equipment for making a presentation using a computer. FIG. 21(B) shows an example of a screen on which a point of interest is indicated by a mark written on a view outputted by a computer 83.

FIG. 22 is a functional block diagram showing a configuration of the computer 83.

### DETAILED DESCRIPTION OF THE INVENTION

Preferably, in the information processing system according to the present invention, the display modes include an interest mode that allows a conspicuous display and a non-interest mode that allows an inconspicuous display. According to this configuration, the display mode control part allows the following, for example. That is, while indication marks that have been inputted previously are being displayed, only the indication mark to which a demonstrator wants to draw attention is displayed in the interest mode so as to be conspicuous, and the other indication marks are displayed in the non-interest mode so as to be inconspicuous.

Preferably, in the information processing system according to the present invention, the display mode control part displays a newest indication mark among the indication marks accumulated in the indication mark storing part in the interest mode.

Immediately after an indication mark is newly inputted, in many cases, the newly inputted indication mark indicates a point of interest. With this in view, the display mode control part allows a newest indication mark to be displayed in the interest mode, and thus a demonstrator is saved the trouble of inputting, at each input of an indication mark, an instruction to put the inputted indication mark in the interest mode by means of the input apparatus.

Preferably, in the information processing system according to the present invention, the input part determines whether the information inputted from the input apparatus represents an indication mark to be newly inputted or is selection information for selecting one of the indication marks that have already been accumulated in the indication mark storing part, and accumulates the information in the indication mark storing part if the information is determined to represent the indication mark to be newly inputted. Further, when the input part determines that the information represents the indication mark to be newly inputted, the display mode control part allows the indication mark to be displayed in the interest mode, and when the input part determines that the information is the selection information, the display mode control part allows the one of the indication marks selected based on the selection information to be displayed in the interest mode. According to this configuration, in the case where by means of the input apparatus, a demonstrator selects a position of an indication mark that has been inputted previously, the indication mark whose position is selected is displayed in the interest mode on the display apparatus. Further, in the case where a demonstrator newly inputs an indication mark, the indication mark also is displayed in the interest mode on the display apparatus.

Preferably, in the information processing system according to the present invention, the display mode control part allows the indication mark other than the indication mark that is displayed in the interest mode to be displayed in the non-interest mode. The display mode control part can allow a display in the non-interest mode of indication marks accumulated in the indication mark storing part except for an indication mark that is newly displayed in the interest mode. According to this configuration, while drawing attention to an indication mark that is being referred to in a demonstration, a demonstrator at the same time can indicate a point that has been referred to previously using an indication mark in the non-interest mode.

Preferably, in the information processing system according to the present invention, the display modes include an invisible mode that allows the indication mark to be invisible. Since the display modes include the invisible mode, when a plurality of indication marks are inputted, at least part of the indication marks can be made invisible by the display mode control part. According to this configuration, for example, it can be avoided that many trails of writing are displayed on the image of the content information, so that the visibility of the content information is impaired.

Preferably, in the information processing system according to the present invention, the display modes include an interest mode that allows a conspicuous display of the indication mark, a non-interest mode that allows an inconspicuous display of the indication mark, and an invisible mode that allows the indication mark to be invisible. Further, when a piece of position information that is inputted from the input apparatus and indicates part of the image indicates a position in the vicinity of one of the indication marks accumulated in the indication mark storing part, the display mode control part allows the one of the indication marks to be displayed in the interest mode and the indication mark other than the one of the indication marks to be displayed in the invisible mode, and when the piece of position information indicates a position not in the vicinity of any of the indication marks accumulated in the indication mark storing part, the display mode control part allows all the indication marks to be displayed in the non-interest mode.

In this manner, the display mode control part controls a display mode of the indication mark. Thus, a display by the display apparatus is in either a state where only an indication mark in the interest mode is displayed or a state where only an indication mark in the non-interest state is displayed. This allows a point of interest to be displayed clearly on the display apparatus.

Preferably, in the information processing system according to the present invention, the indication mark storing part accumulates the indication marks by dividing the indication marks into groups of one or a plurality of the indication marks, and the display mode control part controls the display mode with respect to each of the groups. According to this configuration, a plurality of indication marks can be displayed so as to indicate one point of interest collectively.

Preferably, the information processing system according to the present invention further includes an indication mark identifying part that identifies a shape of each of the indication marks accumulated in the indication mark storing part and classifies the indication marks into one or more mark types according to the shape. Further, the display mode control part controls the display mode with respect to each of the mark types.

Since the display mode control part controls the display mode with respect to each of mark types into which indication marks are classified according to their shapes, for example, indication marks of the same mark type can be displayed in the same display mode. Thus, in a demonstration, a demonstrator can relate a plurality of points of interest to each other, which are indicated by indication marks of the same shape.

Preferably, the information processing system according to the present invention further includes a material changing part that changes according to the indication mark displayed by the indication mark display part, a display of a portion of the material displayed by the material display part that corresponds to the indication mark. According to this configuration, a point of interest indicated by the indication mark is displayed clearly.

The recording medium according to the present invention is a recording medium on which a program that allows a computer to perform processing is recorded. The computer is connected to a display apparatus and to an input apparatus. The processing includes processes of: displaying information regarding a material used for a presentation in the form of an image on the display apparatus; inputting as an indication mark a sequence of consecutively inputted pieces of position information among information inputted from the input apparatus and accumulating the indication mark in a storing unit; displaying the indication mark accumulated in the storing unit together with the material on the display apparatus based on one of display attributes that are accumulated beforehand in the storing unit and respectively represent at least two different display modes of the indication mark; and controlling the display mode of the indication mark based on the information inputted from the input apparatus.

Hereinafter, the present invention will be described in detail by way of embodiments with reference to the appended drawings.

### Embodiment 1

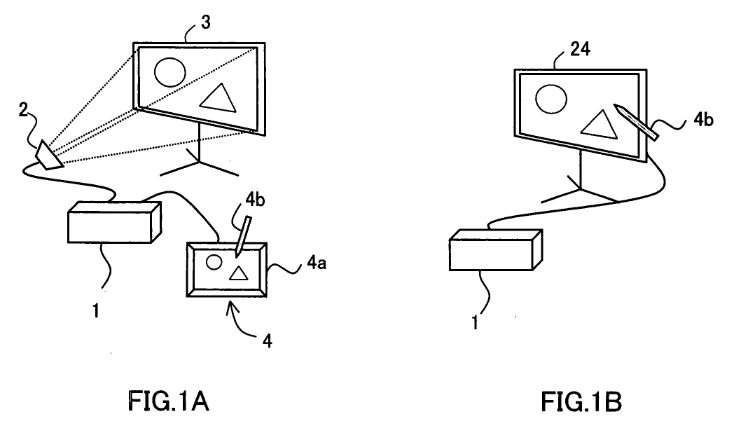

FIG. 1(A) and FIG. 1(B) are diagrams that show examples of a configuration of equipment when an information processing system according to this embodiment is used. The information processing system according to this embodiment is used for a so-called presentation. A presentation is a demonstration that is performed while a material is presented to an audience. Such a presentation is made not only for a business proposal or announcement but also as any form of a demonstration performed while a material is presented such as in, for example, a research presentation, a lecture, a speech, or a play.

In the example shown in FIG. 1(A), an information processing system 1 is connected to a projector 2 and to a tablet apparatus 4. The information processing system 1 is realized using a computer. The computer controls the projector 2 so that an image is displayed on a screen 3. The tablet apparatus 4 includes a tablet 4a and a stylus 4b. A demonstrator operates the stylus 4b on the tablet 4a so as to input position information to the information processing system 1.

In the example shown in FIG. 1(B), the information processing system 1 is connected to a large-screen display 24. As the large-screen display 24, for example, display apparatuses such as a CRT, a PDP, a LCD, and a SED (Surface-conduction Electron-emitter Display). A display of the large-screen display 24 is controlled by the information processing system 1. Further, the large-screen display 24 also has a function of inputting position information. That is, a tablet apparatus is disposed so as to be superimposed on a display screen of the large-screen display 24. The large-screen display 24 also can be regarded as a display-integrated tablet. A demonstrator operates a stylus 4b on the display screen of the large-screen display 24 so that position information on an image can be inputted to the information processing system 1.

Also in the configuration shown in FIG. 1(B), the tablet apparatus 4 shown in FIG. 1(A) further can be connected to the information processing system 1. Further, each of FIGS. 1(A) and 1(B) shows a case where position information is imputed using the stylus 4b as an example with no limitation thereto. Position information also can be inputted using, for example, a pointing device such as a mouse or an input device such as a keyboard.

As described above, as a display apparatus and an input apparatus that are connected to the information processing system 1, various types of devices can be used. The following description is directed mainly to an embodiment in which among such various types of devices, the projector 2 is used as a display apparatus and the tablet apparatus 4 is used as an input apparatus.

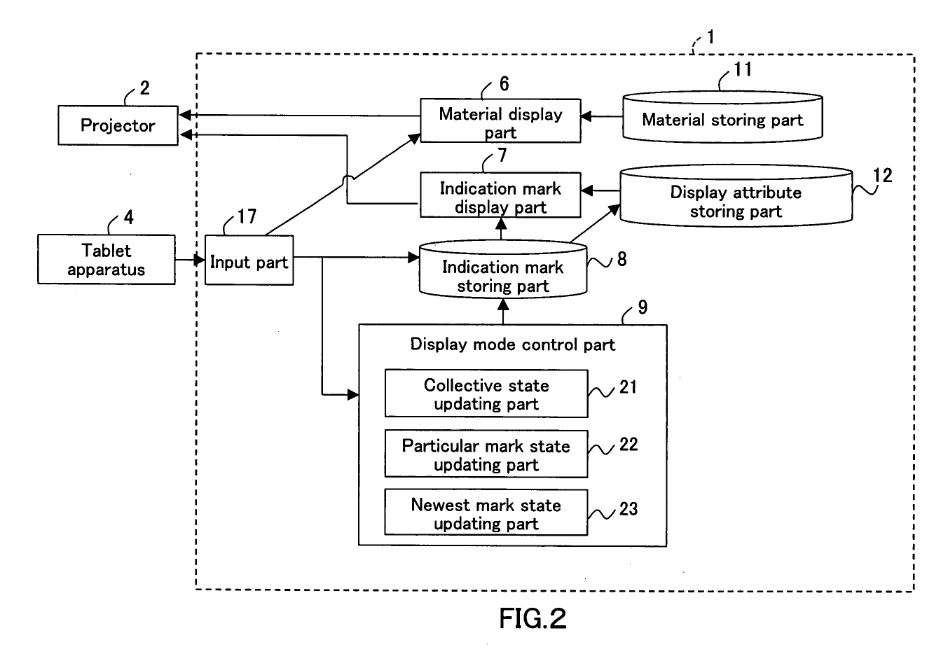

FIG. 2 is a functional block diagram showing an internal configuration of the information processing system 1. As shown in FIG. 2, the information processing system 1 includes an input part 17, a material display part 6, an indication mark display part 7, an indication mark storing part 8, a display mode control part 9, a material storing part 11, and a display attribute storing part 12. The information processing system 1 is connected to the projector 2 as a display apparatus and to the tablet apparatus 4 as an input apparatus.

The material display part 6 outputs a material stored in the material storing part 11 to the projector 2. The projector 2 displays the material in the form of an image on the screen 3 (see FIG. 1(A)). As the material display part 6, a commercially available program for a presentation can be used. Further, in the case where the material is stored in the material storing part 11 in the form of, for example, a text file, a still image file or a moving image file, a program that allows such a file to be displayed can be used as the material display part 6.

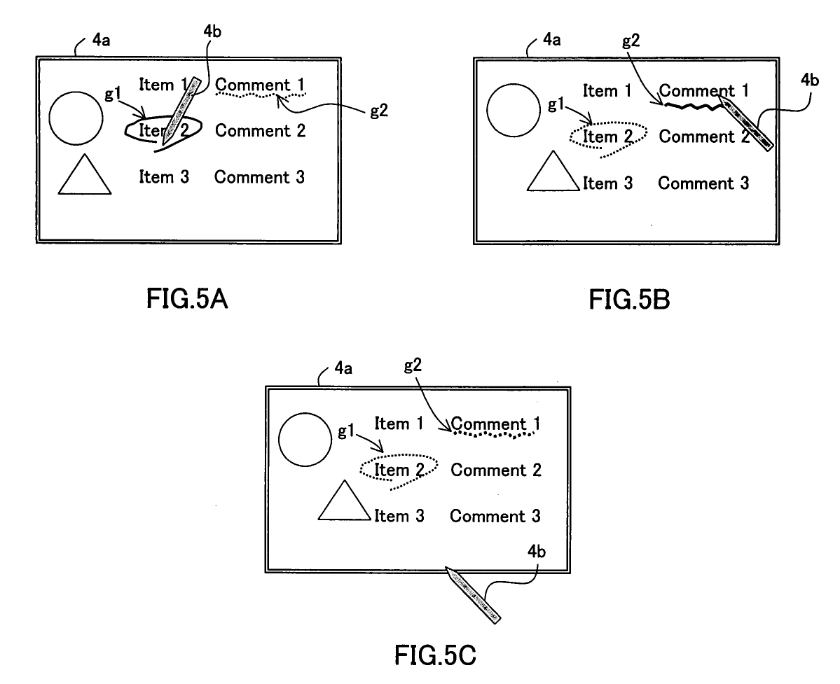

A sequence of pieces of position information that are inputted consecutively by means of the tablet apparatus 4 are recognized as an indication mark by the input part 17. The indication mark storing part 8 stores indication mark information related to the indication mark. FIG. 5(A) is a diagram showing an example of the screen immediately after an indication mark is inputted by means of the tablet apparatus 4. As shown in FIG. 5(A), a trail drawn on the tablet 4a with the stylus 4b is inputted as an indication mark g1. The input part 17 may judge a trail drawn with the stylus 4b to be an indication mark when, for example, the trail is drawn with an end button provided on the stylus 4b being pressed. Indication mark information related to the indication mark g1 inputted at the input part 17 is stored in the indication mark storing part 8.

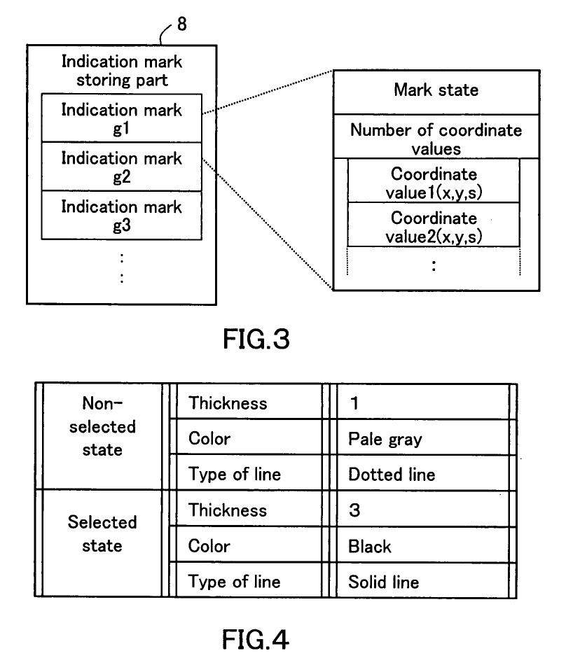

FIG. 3 is a diagram showing an example of a data structure of indication mark information that is stored in the indication mark storing part 8. In the indication mark storing part 8, pieces of indication mark information related respectively to a plurality of indication marks (g1, g2, g3 . . . ) are stored in the order in which they are inputted.

In the example shown in FIG. 3, the indication mark information includes a mark state, the number of coordinate values, and coordinate values. In this example, each indication mark is represented by a plurality of coordinates. Each coordinate value includes a value s that represents a state of a point defined by the coordinate value in addition to an X-coordinate x and a Y-coordinate y that represent a two-dimensional coordinate point. This value s representing a state shows whether a point defined by coordinates (x, y) is at a start point, an endpoint, or a midpoint on a row of a sequence of inputted coordinates. For example, in the case of an indication mark that is a trail of writing made with the stylus 4b, with respect to each pair of coordinates defining the trail, a state s represents a state of being at either a start point, an endpoint, or a midpoint of a drawn image. The plurality of coordinate values are accumulated in the form of, for example, an array. Indication mark information is not limited to the example shown in FIG. 3. For example, an indication mark also may be expressed in a vector form instead of the form of a row of points.

A mark state of an indication mark shows, for example, whether the indication mark is selected or not. In this case, a mark state is either a selected state or a non-selected state. Whether an indication mark is in the selected state or the non-selected state determines the display mode of the indication mark. The display attribute storing part 12 (see FIG. 2) stores a group of display attributes representing a display mode of an indication mark with respect to each of the mark states.

FIG. 4 is a diagram conceptually showing an example of a data structure of display attributes that are stored in the display attribute storing part 12. In the example shown in FIG. 4, groups of display attributes are stored so as to correspond respectively to the selected state and the non-selected state. In this manner, groups of display attributes are stored so as to correspond to the respective mark states, and thus display attributes are determined uniquely based on a mark state of an indication mark. In this example, as the display attributes for the selected state, conditions such as a thickness, a color, a type of a line, brightness, and whether or not an indication mark blinks are set so that the indication mark is displayed in a such mode as to be conspicuous (interest mode). In contrast to this, as the display attributes for the non-selected state, conditions such as a thickness, a color, a type of a line, brightness, and whether or not an indication mark blinks are set so that the indication mark is displayed in such a mode as to be inconspicuous (non-interest mode).

Display attributes also may include, for example, a high brightness display mode, a blinking mode, and a mode that allows dynamic color change in addition to a thickness, a color, and a type of a line. For example, the interest mode of an indication mark can be any of various modes including a mode in which an indication mark is displayed so as to blink and a mode in which the color of an indication mark varies dynamically. On the other hand, for example, the non-interest mode of an indication mark can be any of modes including a mode in which an indication mark is be displayed so as not to blink and a mode in which an indication mark is displayed in a paler color so as to be inconspicuous.

In this embodiment, as an example, the indication mark information shown in FIG. 3 and the display attributes shown in FIG. 4 are stored independently from each other. A data structure, however, is not limited thereto. For example, indication mark information and display attributes may be stored so that each piece of indication mark information corresponds to a group of display attributes.

From the indication mark storing part 8, the indication mark display part 7 (see FIG. 2) obtains coordinate values representing an indication mark and forms an image of the indication mark on a view projected by the projector 2. By referring to the display attribute storing part 12, display attributes for the indication mark to be imaged are determined based on a mark state of the indication mark. For example, in the case where a mark state of an indication mark to be imaged is the selected state, the indication mark display part 7 forms an image of the indication mark using a solid black line with a thickness 3 according to the display attributes shown in FIG. 4.

The display mode control part 9 (see FIG. 2) controls a mark state of indication mark information stored in the indication mark storing part 8 so as to control a display mode of an indication mark. The display mode control part 9 includes a collective state updating part 21, a particular mark state updating part 22, and a newest mark state updating part 23.

The collective state updating part 21 collectively updates mark states of a plurality of pieces of indication mark information stored in the indication mark storing part 8. For example, the collective state updating part 21 updates mark states of all the pieces of indication mark information to the non-selected state.

The particular mark state updating part 22 updates a mark state of a particular piece of indication mark information among indication mark information stored in the indication mark storing part 8. In this embodiment, the particular mark state updating part 22 updates a mark state of a piece of indication mark information that is determined based on input information from the tablet apparatus 4. For example, the particular mark state updating part 22 brings a mark state of a piece of indication mark information to the selected state, which is in a position corresponding to position information inputted from the tablet apparatus 4.

The newest mark state updating part 23 updates a mark state of a newest piece of indication mark information among indication mark information stored in the indication mark storing part 8.

The information processing system 1 can be formed of a computer such as, for example, a personal computer, a workstation, or a server on which a predetermined program is installed. A CPU of the computer performs the predetermined program so that the input part 17, the material display part 6, the indication mark display part 7, and the display mode control part 9 can fulfill their respective functions. Storing media that can be used in the material storing part 11, the display attribute storing part 12, and the indication mark storing part 8 include, for example, portable storing media such as a flexible disk and a memory card, and storing media in a storing device on a network in addition to storing media such as a built-in hard disk or RAM in a computer.

Furthermore, a program that allows a computer to perform processes that are performed respectively by the input part 17, the material display part 6, the indication mark display part 7, and the display mode control part 9 can be installed on an arbitrary computer from a storing medium such as a CD-ROM or by downloading via a communication line, for example. The information processing system 1 thus can be configured.

In addition to the tablet apparatus 4, an input device such as a mouse or a keyboard further can be connected to the information processing system 1.

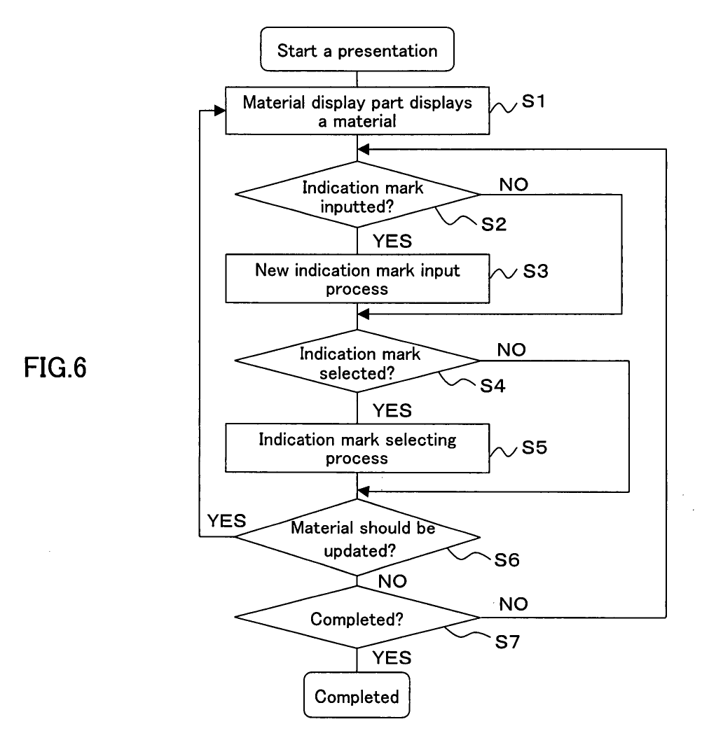

The description is directed next to an example of the operation of the information processing system 1. FIG. 6 is a flow chart showing a flow of processes performed by the information processing system 1 in a presentation.

First, the material display part 6 reads out a material from the material storing part 11 and outputs it to the projector 2 so that the material to be used for the presentation is displayed (Step S1). When the material display part 6 displays the material, it is preferable that an operation mode is selected according to an intended use of the material. The operation mode can be, for example, a demonstration mode in which a material is displayed to be used by a demonstrator in a demonstration or an editing mode in which a material is displayed to be edited. In the case where a material is displayed in a presentation as in this embodiment, it is preferable that the material is displayed in the demonstration mode. A demonstrator performs a demonstration with respect to an audience using the material being displayed.

When performing a demonstration, a demonstrator may input an indication mark so that the indication mark indicates a point to which the attention of an audience should be directed. The tablet apparatus 4 accepts such an input of an indication mark by the demonstrator (Step S2). When an indication mark is inputted by means of the tablet apparatus 4 (YES in Step S2), the information processing system 1 performs a new indication mark input process (Step S3). By the new indication mark input process, the newly inputted indication mark is displayed in a highlighted manner so as to be conspicuous. The new indication mark input process will be detailed later.

Furthermore, for example, in the case of indicating a point indicated by one of indication marks that have already been inputted so that the attention of an audience is directed to the point, a demonstrator also may select the indication mark to which the attention should be directed on a display screen by means of the tablet apparatus 4. The tablet apparatus 4 accepts the selection of an indication mark by the demonstrator (Step S4).

The tablet apparatus 4 may have a proximity sensing function by which position information of the stylus 4b being brought close to the tablet 4a can be obtained even when the stylus 4b is not in contact with the tablet 4a. In the tablet apparatus 4 having this proximate sensing function, for example, the stylus 4b is brought into an area within a predetermined proximity to an indication mark for a predetermined period of time or longer, and thus the indication mark can be selected. Position information regarding the selected indication mark is expressed by, for example, coordinates.

When an indication mark is selected by means of the tablet apparatus 4 (YES in Step S4), the information processing system 1 performs an indication mark selecting process (Step S5). By the indication mark selecting process, the selected indication mark is displayed in a highlighted manner so as to be conspicuous. The indication mark selecting process will be detailed later.

The tablet apparatus 4 also accepts an input of information for updating a material to be displayed (Step 6). When information for updating a material is inputted from the tablet apparatus 4 (YES in Step S6), the material display part 6 newly reads out a material from the material storing part 11 and displays the same (Step S1).

When the tablet apparatus 4 receives an input of a notification that the presentation is completed (YES in Step S7), the information processing system 1 finishes displaying a material. Until displaying of a material is finished, an input of an indication mark is accepted (Step S2), a selection of an indication mark is accepted (Step S4), and information for updating a material is accepted (Step S6) as required.

In the following description, the new indication mark input process (Step S3) and the indication mark selecting process (Step S5) will be detailed.

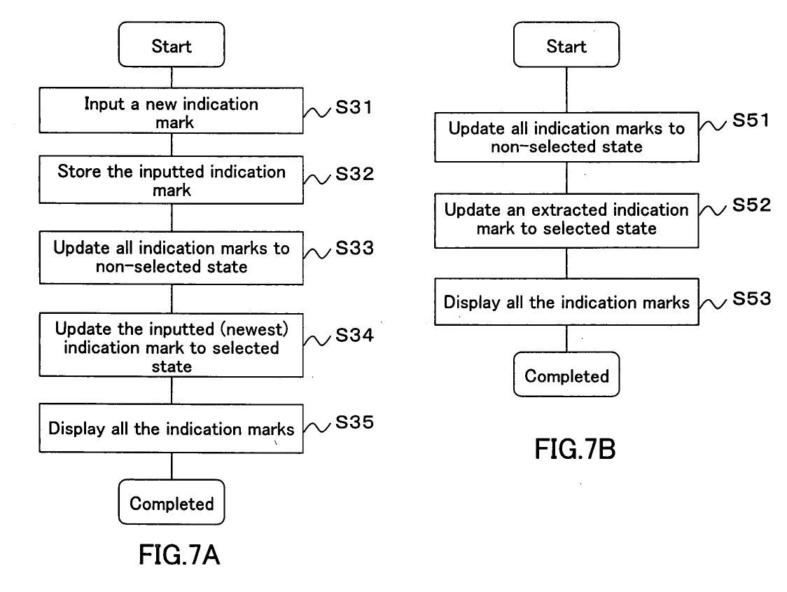

FIG. 7(A) is a flow chart showing an example of the new indication mark input process. For example, a demonstrator operates the stylus 4b on the tablet 4a, and thus a sequence of consecutively inputted pieces of position information are recognized as an indication mark in the input part 17.

Herein, a method of determining whether positional information inputted by means of the tablet apparatus 4 represents an indication mark or not will be described as an example. In the case where a material is displayed in the demonstration mode, when position information is inputted from the tablet apparatus 4 while the button provided at an end of the stylus 4b is being pressed, it is determined that the position information is inputted as an indication mark. When position information is inputted without the button at the end being pressed, it is determined that the position information is inputted so that an indication mark that has already been displayed on the screen is selected. The input part 17 also may be configured so that even when the button at the end of the stylus 4b is being pressed, if a side button is being pressed at the same time, it is not determined that an indication mark is inputted.

An indication mark is not limited to a mark inputted by handwriting and also may be a geometrical figure such as, for example, a straight line or a square drawn with a graphics drawing tool.

When a new indication mark is inputted in the tablet apparatus 4 (Step S31), the indication mark storing part 8 stores indication mark information related to the newly inputted indication mark (Step S32).

At this time, the indication mark display part 7 may display the indication mark in a manner such that portions of the indication mark that are being inputted are displayed in succession. The indication mark being inputted may be displayed in either the mode representing the selected state or the mode representing the non-selected state.

By the collective state updating part 21, mark states of all indication marks that are displayed on the screen among indication marks represented by indication mark information stored in the indication mark storing part 8 are updated to the non-selected state (Step S33). By the newest mark state updating part 23, the mark state of the newly inputted indication mark, namely, the newest indication mark is updated to the selected state (Step S34). Thus, among indication mark information regarding the indication marks that are displayed on the screen, only the mark state of the newest piece of indication mark information is brought to the selected state, and the mark states of the other pieces of indication mark information are brought to the non-selected state.

The indication mark display part 7 displays the indication mark information stored in the indication mark storing part 8 on a view projected by the projector 2 (Step S35). Display attributes for each of the indication marks to be displayed at this time are determined based on the mark states of the respective pieces of indication mark information, and thus only the newest indication mark is displayed in a mode different from that of the other indication marks.

A screen display in which indication marks are displayed upon an input of a new indication mark (Step S35) is, for example, as shown in FIG. 5(A). In the example shown in FIG. 5(A), the newest indication mark g1 is displayed using a thick line so as to be conspicuous (interest mode), and the other indication mark is displayed using a dotted line so as to be inconspicuous (non-interest mode).

In the process shown in FIG. 7(A), as an example, after a new indication mark is inputted, all indication marks are brought to the non-selected state and then the newest indication mark is brought to the selected state. However, the new indication mark input process is not limited thereto. The new indication mark input process may be, for example, a process in which at a point in time when the input part 17 determines that an input from the tablet apparatus 4 is an input of a new indication mark, the display mode control part 9 brings already-existing indication marks to the non-selected state, and the indication mark being inputted is stored in the selected state and at the same time, is displayed by the indication mark display part 7.

FIG. 7(B) is a flow chart showing an example of the indication mark selecting process. The indication mark selecting process is performed in the case where a demonstrator selects an indication mark on the screen by means of the tablet apparatus 4. For example, a demonstrator indicates an indication mark to be selected using the stylus 4b, and thus the indication mark is selected. The input part 17 may determine that an indication mark is selected, for example, in the case where the stylus 4b is pointed at the indication mark without the button provided at the end thereof being pressed.

The input part 17 extracts a piece of indication mark information that corresponds to a position indicated with the stylus 4b from the indication mark storing part 8. The input part 17 thus can determine a selected indication mark. For example, a piece of indication mark information representing an indication mark is extracted, part of which exists within a circle having a predetermined radius from coordinates at a position indicated.

When an indication mark is selected, by the collective state updating part 21, mark states of all indication marks that are displayed on the screen among indication marks represented by indication mark information stored in the indication mark storing part 8 are updated to the non-selected state (Step S51). By the particular mark state updating part 22, the mark state of the selected indication mark is updated to the selected state (Step S52). Thus, among indication mark information regarding the indication marks displayed on the screen, only the mark state of the selected piece of indication mark information is brought to the selected state, and the mark states of the other pieces of indication mark information are brought to the non-selected state.

The indication mark display part 7 displays the indication mark information stored in the indication mark storing part 8 on a view projected by the projector 2 (Step S53). At this time, only the selected indication mark is displayed in a mode different from that of the other indication marks.

A screen display in which indication marks are displayed (Step S53) is, for example, as shown in FIG. 5(B). In the example shown in FIG. 5(B), a selected indication mark g2 is displayed using a thick line so as to be conspicuous (interest mode), and the other indication mark g1 is displayed using a dotted line so as to be inconspicuous (non-interest mode). That is, when the demonstrator brings the stylus 4b close to an indication mark to which the attention of an audience should be directed, the indication mark is displayed using a thick line by the position selecting process shown in FIG. 7(B).

The above-described process is performed when an indication mark is selected. Similarly to this process, in the case where a position indicated with the stylus 4b or the like is apart from all indication marks, a process may be performed in which the collective state updating part 21 brings mark states of all pieces of indication mark information to the non-selected state. Thus, for example, when a demonstrator wants to cancel a display of an indication mark in the interest mode, the demonstrator indicates any point other than the indication mark, and thus all indication marks can be displayed so as to be inconspicuous.

FIG. 5(C) is a diagram showing an example of the screen when all indication marks are displayed in the non-interest mode. As shown in FIG. 5(C), for example, when a demonstrator moves the stylus 4b to a position apart from all indication marks, the collective state updating part 21 brings mark states of all pieces of indication mark information to the non-selected state. The indication mark display part 7 displays all the indication marks in the non-selected state. As a result, all the indication marks including an indication mark that has been in the selected state previously are brought to the non-selected state and displayed using dotted lines so as to be inconspicuous.

Furthermore, an indication mark also can be displayed in the non-interest mode after an elapse of a fixed period of time while being displayed without a change of the display mode immediately after the stylus 4b is brought apart from a position of the indication mark. In this case, by the particular mark state updating part 22, an indication mark in the selected state is updated to the non-selected state if an operation of selecting another indication mark is not performed before an elapse of a fixed period of time after the stylus 4b is brought to a position apart from the indication mark in the selected state.

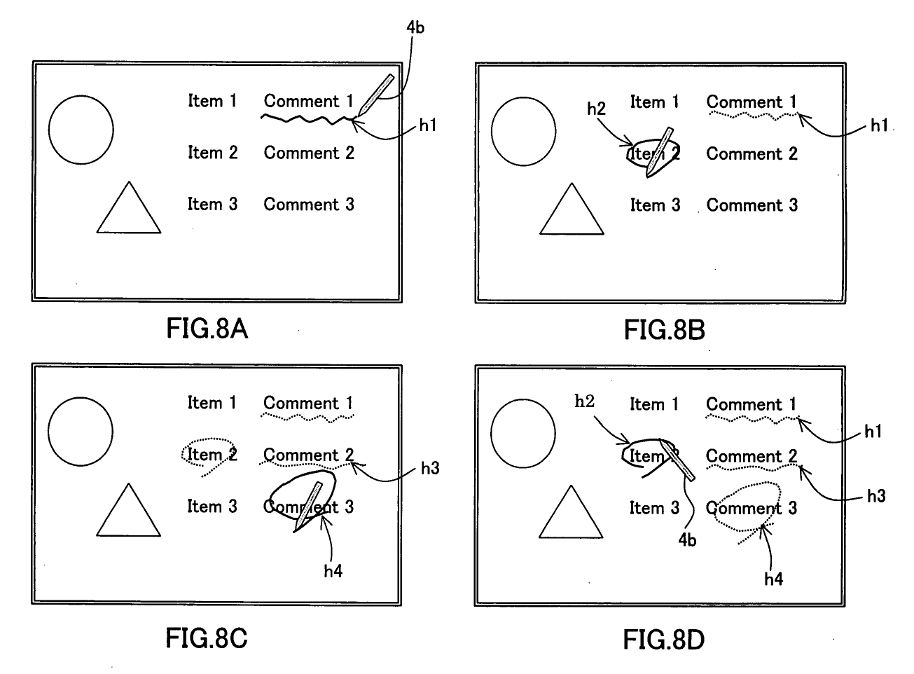

FIGS. 8(A), 8(B), 8(C) and 8(D) are diagrams that show examples of screen displays realized by operations of the information processing system 1, which are shown in FIGS. 6 and 7, respectively. These screen displays show a transition that occurs in the order of FIGS. 8(A), 8(B), 8(C) and 8(D).

First, as shown in FIG. 8(A), an indication mark h1 is drawn at a position of “Comment 1” and stored in the indication mark storing part 8. Immediately after being inputted, the indication mark h1 is in the selected state and stored in that state. The indication mark display part 7 displays the indication mark h1 using a thick solid black line.

Next, as shown in FIG. 8(B), an indication mark h2 in the form of a circle is drawn at a position of “Item 2”. At this time, the indication mark h1 that has been inputted previously is set to be in the non-selected state by the collective state updating part 21. The indication mark h2 that is newly drawn is set to be in the selected state by the newest mark state updating part 23. As a result, the indication mark display part 7 displays the indication mark h1 using a thin dotted pale gray line and the indication mark h2 using a thick solid black line.

As shown in FIG. 8(C), an indication mark h3 and an indication mark h4 are drawn in succession at a position of “Comment 2” and a position of “Comment 3”, respectively. As shown in FIG. 8(D), after the four indication marks h1, h2, h3 and h4 are inputted, the stylus 4b is moved onto the indication mark h2. Thus, first, mark states of all the indication marks h1, h2, h3 and h4 are updated to the non-selected state by the collective state updating part 21, and then the mark state of the indication mark h2 is brought to the selected state by the particular mark state updating part 22. As a result, only the indication mark h2 is displayed using a thick solid black line, namely, in the interest mode.

In the case of using a mouse instead of the tablet apparatus 4, for example, a demonstrator moves the mouse without pressing a button of the mouse so that a mouse pointer is moved onto an indication mark to be selected, and thus the indication mark can be selected.

The following description is directed to modification examples of this embodiment.

### MODIFICATION EXAMPLE 1

In the above-described embodiment, as an example, an indication mark to be highlighted is selected by a selection among indication marks on the screen. A method of selecting an indication mark to be highlighted is not limited to the above-described method in which an indication mark on the screen is indicated. For example, an indication mark to be displayed in a highlighted manner can be selected also by a selection among buttons that are provided on a screen and correspond respectively to indication marks.

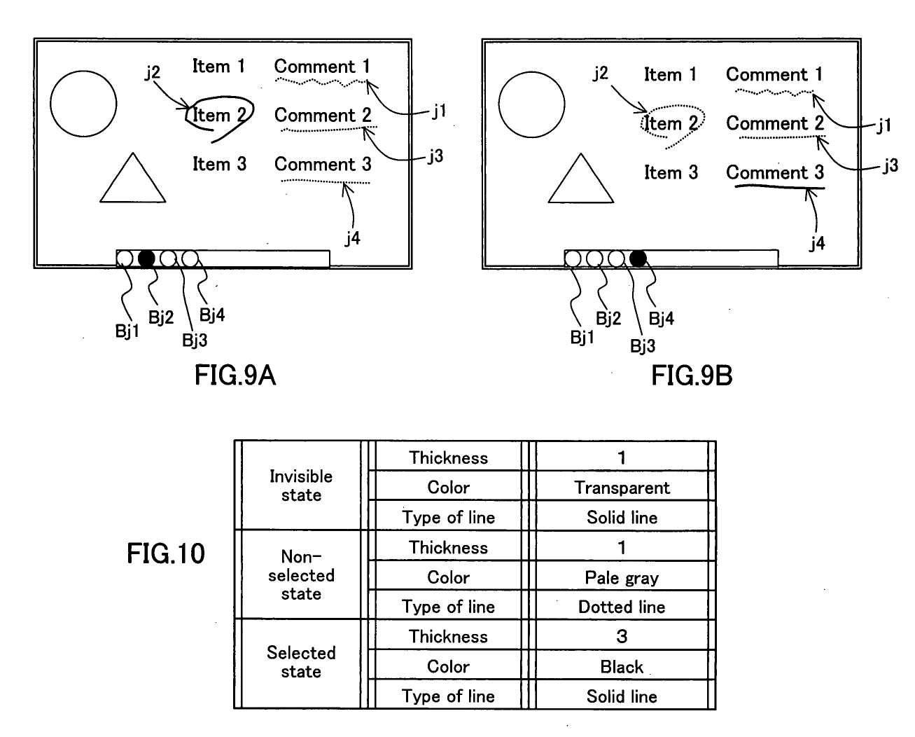

FIGS. 9(A) and 9(B) show examples of a screen display when an indication mark is selected through a selection among buttons displayed on the screen. In the screen shown in FIG. 9(A), four indication marks j1, j2, j3 and j4 are displayed. Four buttons Bj1, Bj2, Bj3 and Bj4 are provided at a lower portion of the screen so as to correspond respectively to the indication marks j1, j2, j3 and j4.

A demonstrator selects the button corresponding to the indication mark to be selected so that the indication mark can be selected. For example, in the case where the demonstrator wants to allow the indication mark j2 to be displayed in the interest mode as shown in FIG. 9(A), the demonstrator selects the button Bj2. Further, when the button Bj4 is selected as shown in FIG. 9(B), the indication mark j4 is displayed in the interest mode.

Buttons for selecting an indication mark may be displayed only on the screen of the tablet apparatus 4 and not on the screen to be shown to an audience (screen 3). Further, buttons also may be replaced by, for example, icons, a row of characters or the like.

As described above, in the method in which a selection is made among buttons displayed on a screen, it is possible to select an indication mark by means of a keyboard without inputting position information using a tablet apparatus or a pointing device such as a mouse. Further, the method also is advantageous in that during a presentation, a demonstrator can select an indication mark easily without changing a line of sight. This method also can be used in combination with the method shown in FIG. 8 in which a selection is made through an input of position information.

### MODIFICATION EXAMPLE 2

In the case of selecting an indication mark by inputting position information, the number of indication marks that are selected in one operation is not limited to one. For example, a configuration is possible in which when a demonstrator presses an indication mark with the stylus 4b while pressing a side switch of the stylus 4b, the indication mark is selected, and when other indication marks are selected consecutively within a fixed period of time, all the indication marks selected consecutively are brought to the selected state.

For example, in a possible mechanism, within a second after an indication mark is selected, another indication mark is selected, and thus the plurality of indication marks can be selected. Moreover, a mechanism also is possible in which after a certain indication mark is selected, one second or longer has elapsed until a next indication mark is selected, and thus only the indication mark selected that had been selected last is brought to the selected state.

### MODIFICATION EXAMPLE 3

In the above-described embodiment, a mark state of indication mark information stored in the indication mark storing part 8 (see FIG. 3) can be either of two types, namely, the selected state and the non-selected state. There also may be three or more types of mark states. This modification example describes a case in which there are three types of mark states that are a selected state, a non-selected state and an invisible state.

FIG. 10 is a diagram showing an example of a data structure of display attributes that are stored in the display attribute storing part 12. In the example shown in FIG. 10, groups of display attributes are stored so as to correspond respectively to the three types of mark states, namely, the selected state, the non-selected state and further, the invisible state. As a display attribute for the invisible state, a color is set to be transparent. Therefore, an indication mark displayed according to the display attributes for the invisible state is displayed so as to be invisible, namely in an invisible mode. Since there are three types of display modes as described above, for example, one of indication marks that are displayed on the screen is brought to the selected state, while the other indication marks are brought to the invisible state, and thus only the one of indication marks can be displayed in the interest mode.

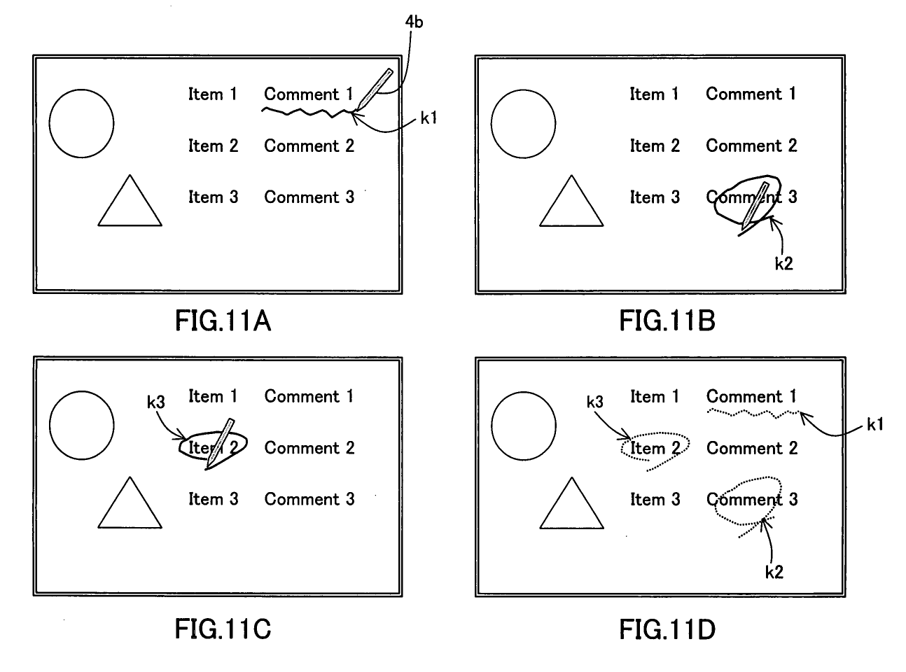

FIGs. 11(A), 11(B), 11(C) and 11(D) are diagrams that show examples of screen displays when there are three types of mark states, namely, the selected state, the non-selected state and the invisible state. The screen displays shown in FIG. 11 show a transition that occurs in the order of FIGs. 11(A), 11(B), 11(C) and 11(D).

FIG. 11(A) is a diagram showing a display immediately after an indication mark k1 is inputted to indicate “Comment 1”. Only the indication mark k1 is displayed using a thick solid black line, namely, in the interest mode. FIG. 11(B) is a diagram showing a display immediately after an indication mark k2 is inputted to indicate “Comment 3”. When the indication mark k2 is inputted, after mark states of all pieces of indication mark information are updated to the invisible state by the collective state updating part 21, the mark state of the newest indication mark k2 is updated to the selected state by the newest mark state updating part 23. As a result, by the indication mark display part 7, only the indication mark k2 is displayed using a thick solid black line, namely, in the interest mode, and other indication marks are displayed so as to be transparent. Accordingly, k1 becomes invisible. FIG. 11(C) is a diagram showing a display immediately after an indication mark k3 is inputted to indicate “Item 2”. Similarly, only the indication mark k3 is displayed using a thick solid black line, namely, in the interest mode.

FIG. 11(D) is a diagram showing a display when the stylus 4b is moved to a position apart from positions of all the indication marks. When the stylus 4b is moved to a position apart from all the indication marks, mark states of all pieces of indication mark information are updated to the non-selected state by the collective state updating part 21. As a result, the indication marks k1, k2 and k3 are displayed using a thin dotted pale gray line, namely, in the non-interest mode.

### MODIFICATION EXAMPLE 4

This modification example describes a case where there are three types of mark states that are a selected state, a non-selected state and a selection-locked state.

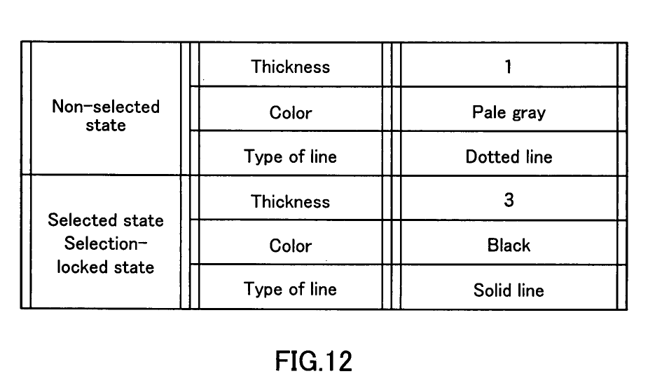

FIG. 12 is a diagram showing an example of a data structure of display attributes that are stored in the display attribute storing part 12. In the example shown in FIG. 12, as for the selected state and the selection-locked state, corresponding display attributes are set to be common to both the states.

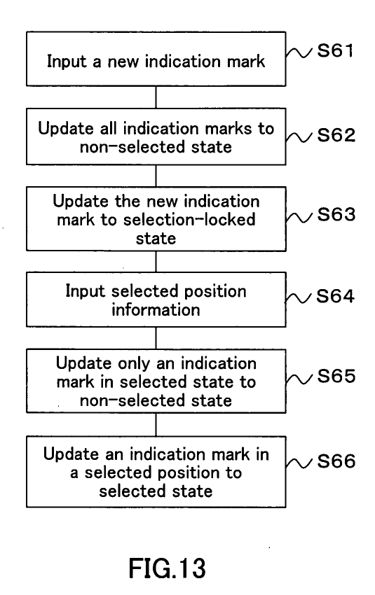

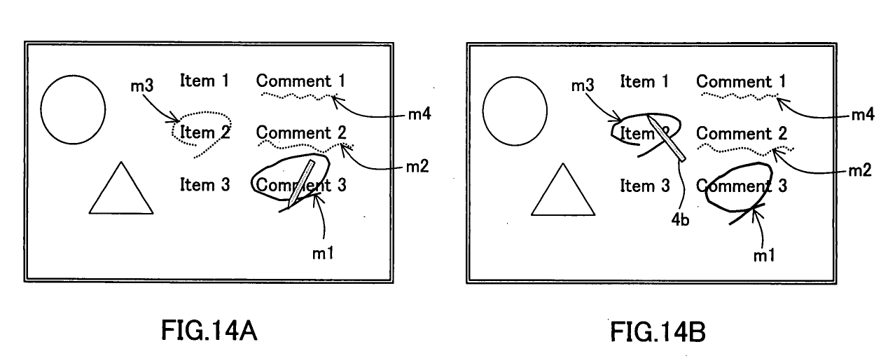

By referring to FIGS. 13 and 14, this modification example describes processes in the case where after an indication mark is newly inputted, a position of another indication mark is selected. FIG. 13 is a diagram showing a flow of the processes in the case where after an indication mark is newly inputted, a position of another indication mark is selected, and FIG. 14 shows a transition of a screen display that occurs in this case.

As shown in FIG. 13, when an indication mark is newly inputted in a state where pieces of indication mark information regarding a plurality of indication marks m2, m3 and m4 have already been stored in the indication mark storing part 8 (Step S61), first, mark states of all the pieces of indication mark information are updated to the non-selected state by the collective state updating part 21 (Step S62). After that, by the newest mark state updating part 23, the mark state of the indication mark m1 that is newly stored is updated to the selection-locked state (Step S63).

Thus, as shown in FIG. 14(A), only the piece of indication mark information regarding the indication mark m1 that is newly inputted is brought to the selection-locked state, and thus the indication mark m1 is displayed using a thick solid black line, namely, in the interest mode. The pieces of indication mark information regarding the other indication marks m2, m3 and m4 are in the non-selected state, and thus the indication marks m2, m3 and m4 are displayed using thin dotted pale gray lines.

Even if another indication mark is selected in a later process, the indication mark m1 in the selection-locked state is not updated to the non-selected state. The indication mark m1 is updated to the non-selected state in the case where another indication mark is newly inputted.

After the indication mark m1 is inputted, as shown in FIG. 14(B), a demonstrator selects a position of the other indication mark m3 with the stylus 4b, and thus position information is inputted (Step S64 (see FIG. 13)).

In this case, by the collective state updating part 21, the mark states of the pieces of indication mark information stored in the indication mark storing part 8 are updated to the noon-selected state (Step S65). At this time, the operation in which the collective state updating part 21 updates the mark states of the pieces of indication mark information stored in the indication mark storing part 8 to the non-selected state is applied only to the pieces of indication mark information regarding the indication marks m2, m3 and m4 in the selected state, and not to the piece of indication mark information regarding the indication mark m1 in the selection-locked state. That is, only the pieces of indication mark information regarding the indication marks m2, m3 and m4 in the selected state are updated to the non-selected state, and the piece of indication mark information regarding the indication mark m1 in the selection-locked state is not updated.

After that, by the particular mark state updating part 22, the mark state of the indication mark m3 at the selected position to the selected state (Step S66). As a result, as shown in FIG. 14(B), only the indication marks m1 and m3 are displayed using thick solid black lines.

As described above, indication mark information to be updated by the collective state updating part 21 can be controlled using a mark state.

### Embodiment 2

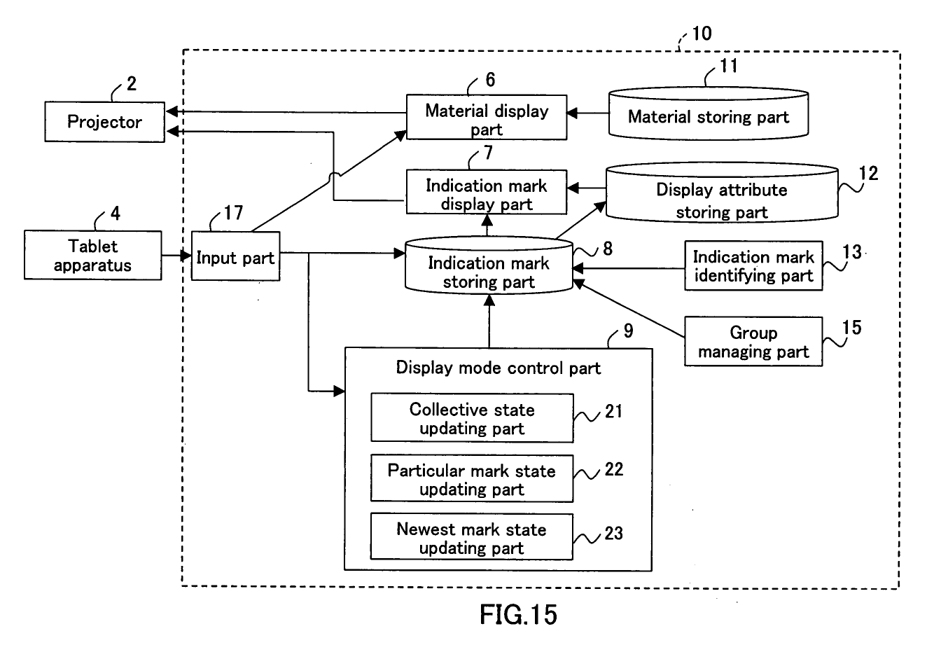

FIG. 15 is a functional block diagram showing a configuration of an information processing system in Embodiment 2. In FIG. 15, like reference numerals refer to similar components to those of the information processing system 1 shown in FIG. 2, for which duplicate descriptions are omitted.

An information processing system 10 shown in FIG. 15 further includes an indication mark identifying part 13 and a group managing part 15. The indication mark identifying part 13 identifies a shape represented by each piece of indication mark information accumulated in an indication mark storing part 8 and makes a classification into one or more mark types depending on the shape. The indication mark identifying part 13 stores the mark types resulting from the classification with respect to each piece of indication mark information.

The group managing part 15 manages grouping information for grouping pieces of indication mark information stored in the indication mark storing part 8.

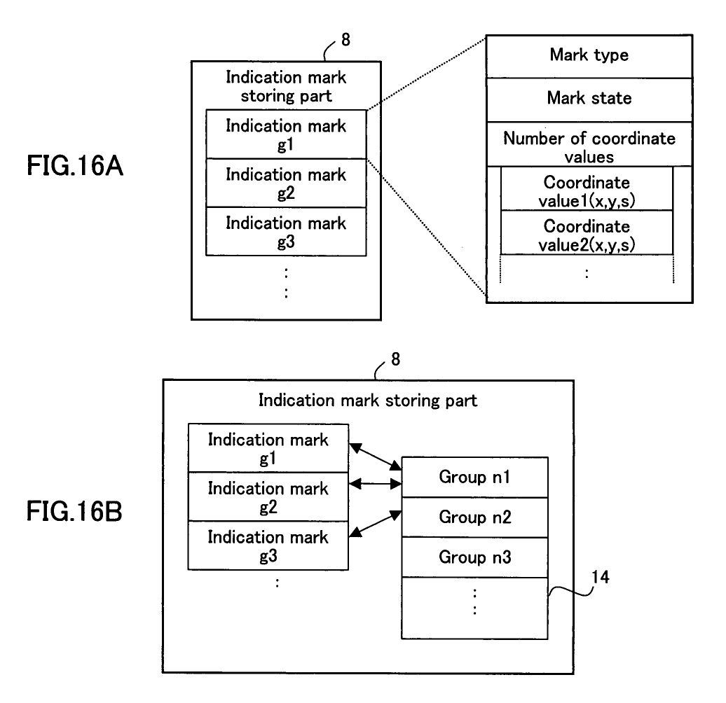

FIG. 16(A) is a diagram showing an example of a data structure of indication mark information that is stored in the indication mark storing part 8. In the example shown in FIG. 16(A), each piece of indication mark information includes a mark type, a mark state, the number of coordinate values, and coordinate values. The mark type will be detained later.

Furthermore, the indication mark storing part 8 may store indication mark information so that it corresponds to grouping information. FIG. 16(B) is a diagram showing an example of a data structure when indication mark information is stored at the indication mark storing part 8 so as to correspond to grouping information. In the indication mark storing part 8 shown in FIG. 16(B), a group table 14 exists in addition to the indication mark information. In the group table 14, groups n1, n2, n3 . . . that are data on groups are accumulated. Pieces of indication mark information are set to correspond respectively to the groups using reciprocal pointers. Thus, for example, in the case where a plurality of indication marks belong to a group, pieces of indication mark information regarding the plurality of indication marks can be set to correspond to grouping information regarding the group using a reciprocal pointer.

As for grouping of indication marks, for example, one or more indication marks that are inputted consecutively within a predetermined period of time can be collected into a group. The predetermined period of time may be, for example, about a second. Thus, geometrical figures each formed of a plurality of indication marks, namely, figures each formed of a plurality of drawn images such as a double line, a double circle and an asterisk are collected and stored respectively as one group.

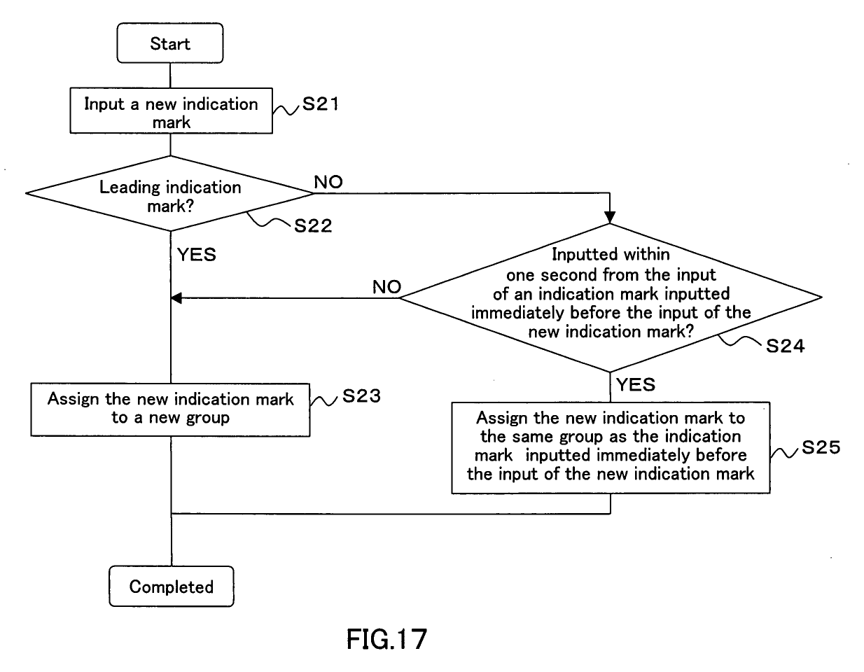

FIG. 17 is a flow chart showing an example of processes in which when inputted, a new indication mark is stored by an input part 17 so as to correspond to a group. As shown in FIG. 17, when a new indication mark is inputted from a tablet apparatus 4 (Step S21), the input part 17 judges whether the indication mark is a leading indication mark (Step S22). When the inputted indication mark is a leading indication mark (YES in Step S22), the input part 17 stores the indication mark as an indication mark that belongs to a new group (Step S23).

When the inputted indication mark is not a leading indication mark (NO in Step S22), the input part 17 judges whether a period of time from the time of an input of an indication mark that has been-inputted immediately before the input of the indication mark that is newly inputted to the time of the input of the indication mark that is newly inputted is within one second (Step S24). When the period of time is within one second (YES in Step S24), by the input part 17, the newly inputted indication mark is stored so as to belong to the same group as the indication mark that has been inputted immediately before the input of the newly inputted indication mark (Step S25). When the period of time is not within one second, by the input part 17, the indication mark is stored as an indication mark that belongs to a new group (Step S23).

A display mode control part 9 sets a mark state with respect to each group. That is, the display mode control part 9 collectively handles a group of pieces of indication mark information as one piece of indication mark information.

For example, when updating a mark state of a particular piece of indication mark information to the selected state, a particular mark state updating part 22 checks whether the indication mark belongs to a group. If the indication mark belongs to the group, the particular mark state updating part 22 updates all indication marks that belong to the same group to the selected state. Similarly, when updating a particular indication mark to the non-selected state, the particular mark state updating part 22 updates all indication marks that belong to the same group as the particular indication mark to the non-selected state.

Thus, for example, a group of pieces of indication mark information that indicate a common point of interest while having been inputted as a plurality of indication marks such as an underline drawn using a double line can be handled as one piece of indication mark information. Such a group of pieces of indication mark information can be, for example, a square formed by inputting sides, one at a time, or parentheses. By grouping such indication marks, the indication marks can be used effectively as pieces of indication mark information that indicate one location.

The description is directed next to a mark type. For example, in the case where there are a normal indication mark, a highlighted indication mark and an enclosing indication mark as mark types, the indication mark identifying part 13 identifies to which of these three types an indication mark applies. For example, when used as an indication mark, a single-line underline is classified as a normal indication mark, a double underline is classified as a highlighted indication mark, and an enclosing circle is classified as an enclosing indication mark.

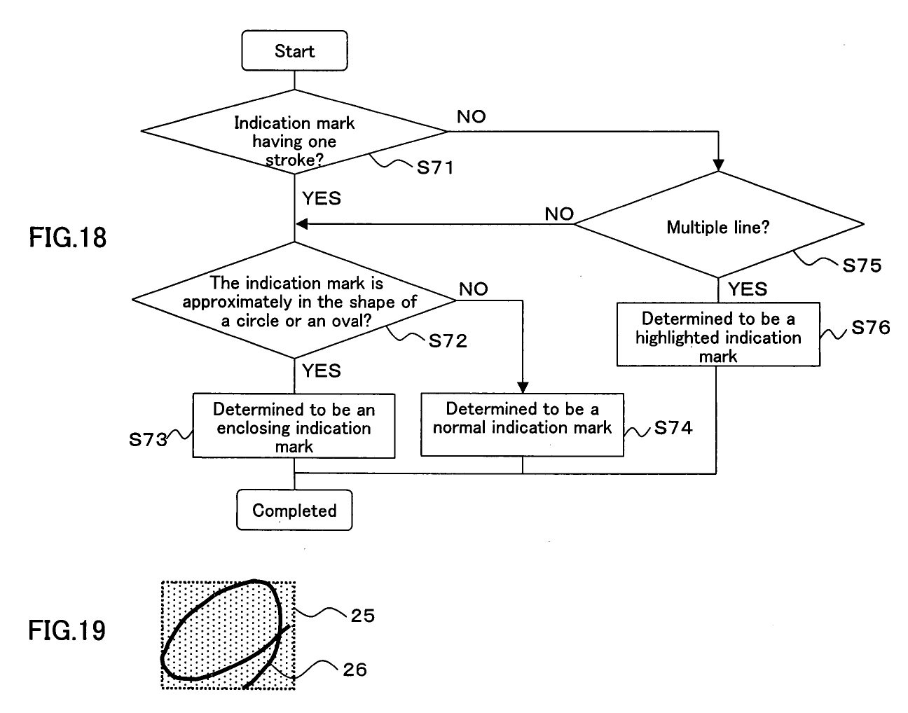

The description is directed next to processes in which the indication mark identifying part 13 identifies an indication mark. FIG. 18 is a flow chart showing a flow of the processes in which the indication mark identifying part 13 identifies an indication mark.

First, the indication mark identifying part 13 judges whether an indication mark to be identified is composed of one stroke (Step S71). An indication mark composed of two or more strokes is either of the following two types. That is, such an indication mark is either of: an indication mark formed of a plurality of one-stroke indication marks collectively belonging to one group; or one indication mark having two or more strokes. The indication mark identifying part 13 judges whether the indication mark to be identified applies to either of these two types. According to a group configuration stored in the indication mark storing part 8, it is judged whether the indication mark to be identified belongs to the type of a plurality of one-stroke indication marks collectively belonging to one group. According to whether in the indication mark storing part 8 as shown in FIGS. 3 and 16(A), the state s of coordinates of an indication mark includes two or more states representing endpoints of a drawn image, it is judged whether one indication mark has two or more strokes.

When it is judged that the indication mark is composed of one stroke (YES in Step S71), it is judged whether the indication mark is approximately in the shape of a circle or an oval (Step S72). When it is judged that the indication mark is not composed of one stroke (NO in Step S71), it is judged whether the indication mark is formed of a multiple line (Step S75).

When the indication mark is formed of a multiple line (YES in Step S75), it is determined that the indication mark is a highlighted indication mark (Step S76). When the indication mark is not formed of a multiple line (NO in Step S75), the indication mark identifying part 13 judges whether the indication mark is approximately in the shape of a circle or an oval (Step S72).

When the indication mark is approximately in the shape of a circle or an oval (YES in Step S72), it is determined that the indication mark is an enclosing indication mark (Step S73). When the indication mark is not approximately in the shape of a circle or an oval (NO in Step S72), it is determined that the indication mark is a normal indication mark (Step S74).

In judging whether an indication mark is formed of a multiple line in Step S75, for example, when: (1) all indication marks are formed of a straight line extending in a lateral direction; (2) start points of all the indication marks are close to each other; and (3) endpoints of all the indication marks are close to each other, the indication mark identifying part 13 can judge that these indication marks forms a multiple line. The indication mark identifying part 13 makes the above judgment based on each coordinate value included in indication mark information.

In making a judgment in Step S72, for example, if an identification mark satisfies conditions: (1) that a start point and an endpoint of the indication mark are close to each other; (2) that a circumscribed frame of the indication mark has an aspect ratio in a rage of 0.2 to 5; and (3) that the indication mark is turned always in one direction (turned to the right/turned to the left), the indication mark identifying part 13 can judge that the indication mark is approximately in the shape of a circle or an oval.

The display mode control part 9 controls a mark state according to a type of an indication mark. The display mode control part 9 may change, for example, a method of selecting an indication mark or canceling the selection of the indication mark according to the type of the indication mark.

Furthermore, a display mode can be changed according to a type of an indication mark. For example, a normal indication mark may be displayed in a red color when the mark is in the interest mode and displayed in a pale gray color when the mark is in the non-interest mode.

Furthermore, for example, a highlighted indication mark may be displayed in a red color so as to blink when the mark is in the interest mode and displayed in the same manner as a normal indication mark when the mark is in the non-interest mode.

FIG. 19 is a diagram showing an example of an interest mode for an enclosing indication mark. When in the interest mode, an enclosing indication mark 26 may be displayed in a red color with half-tone dot meshing in a pale yellow color provided on the periphery thereof. The half-tone dot meshing can be displayed, for example, in a region inside a circumscribed frame 25 surrounding the enclosing mark 26. When displayed in the non-interest, the enclosing indication mark may be displayed in the same manner as a normal indication mark.

### Embodiment 3

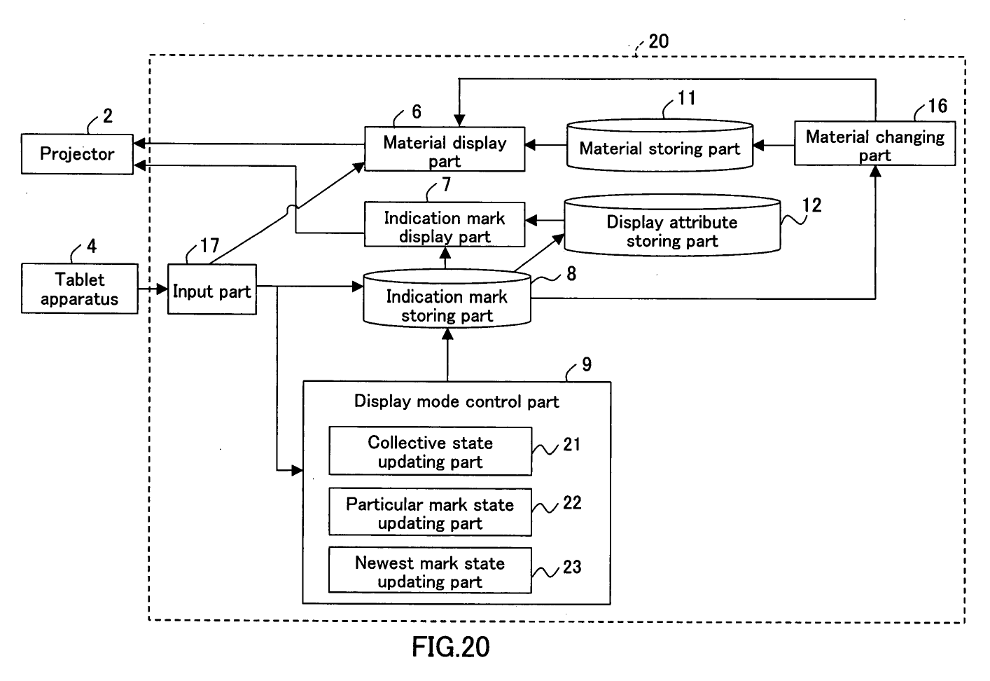

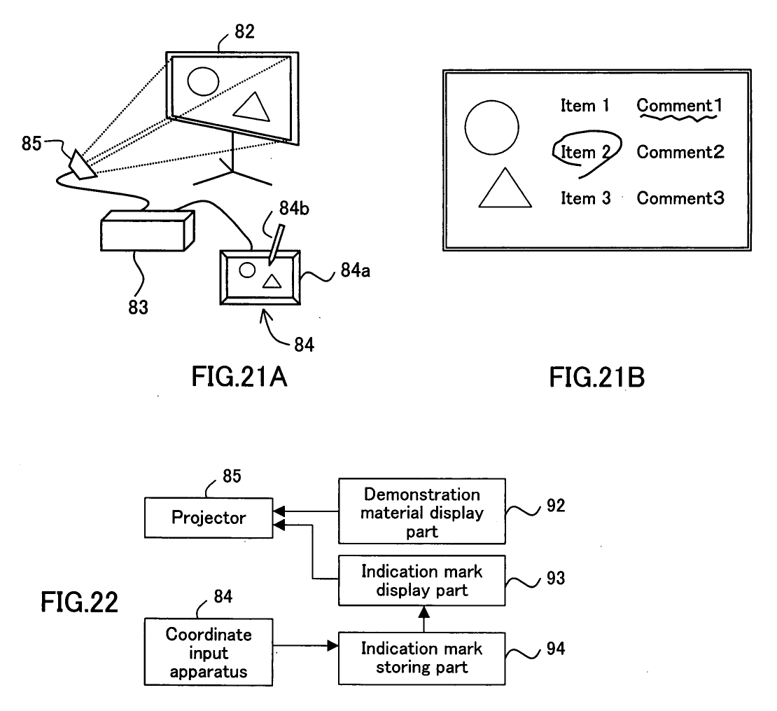

FIG. 20 is a functional block diagram showing a configuration of an information processing system in Embodiment 3. In FIG. 20, like reference numerals refer to similar components to those of the information processing system 1 shown in FIG. 2, for which duplicate descriptions are omitted.

An information processing system 20 shown in FIG. 20 further includes a material changing part 16. The material changing part 16 updates according to an indication mark displayed by an indication mark display part 7, a display of a portion of a material displayed by a material display part 6 that corresponds to the indication mark.

By the material changing part 16, for example, a display of a partial region of a material that corresponds to an indication mark selected by means of a tablet apparatus 4 is changed to a highlighted display. In the case where an indication mark selected by means of the tablet apparatus 4 is an underline, the material changing part 16 can change a color of a text indicated by the underline or make the text blink. The material changing part 16 may change a display of a material by controlling a display by the material display part 6 or by changing a material stored in a material storing part 11.

The present invention provides an information processing system that is effectively used to perform a demonstration with respect to an audience in which while showing the audience a display screen controlled using a computer, a displayed content is indicated by means of a coordinate input means.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An information processing system that is connected to a display apparatus and to an input apparatus so as to be used for a presentation, comprising:
a material display part that displays information regarding a material used for the presentation in the form of an image on the display apparatus;
an input part that inputs as an indication mark a sequence of consecutively inputted pieces of position information among information inputted from the input apparatus;
an indication mark storing part that accumulates the indication mark inputted at the input part;
a display attribute storing part in which display attributes that respectively represent at least two different display modes of the indication mark are accumulated beforehand;
an indication mark display part that displays the indication mark accumulated in the indication mark storing part together with the material on the display apparatus in one of the display modes represented respectively by the groups of display attributes accumulated in the display attribute storing part; and
a display mode control part that controls the display mode of the indication mark based on the information inputted from the input apparatus.

2. The information processing system according to claim 1,
wherein the display modes include an interest mode that allows a conspicuous display and a non-interest mode that allows an inconspicuous display.

3. The information processing system according to claim 2,
wherein the display mode control part displays a newest indication mark among the indication marks accumulated in the indication mark storing part in the interest mode.

4. The information processing system according to claim 2,
wherein the input part determines whether the information inputted from the input apparatus represents an indication mark to be newly inputted or is selection information for selecting one of the indication marks that have already been accumulated in the indication mark storing part, and accumulates the information in the indication mark storing part if the information is determined to represent the indication mark to be newly inputted, and
when the input part determines that the information represents the indication mark to be newly inputted, the display mode control part allows the indication mark to be displayed in the interest mode, and when the input part determines that the information is the selection information, the display mode control part allows the one of the indication marks selected based on the selection information to be displayed in the interest mode.

5. The information processing system according to claim 3,
wherein the display mode control part allows the indication mark other than the indication mark that is displayed in the interest mode to be displayed in the non-interest mode.

6. The information processing system according to claim 4,
wherein the display mode control part allows the indication mark other than the indication mark that is displayed in the interest mode to be displayed in the non-interest mode.

7. The information processing system according to claim 1,
wherein the display modes include an invisible mode that allows the indication mark to be invisible.

8. The information processing system according to claim 1,
wherein the display modes include an interest mode that allows a conspicuous display of the indication mark, a non-interest mode that allows an inconspicuous display of the indication mark, and an invisible mode that allows the indication mark to be invisible, and
when a piece of position information that is inputted from the input apparatus and indicates part of the image indicates a position in the vicinity of one of the indication marks accumulated in the indication mark storing part, the display mode control part allows the one of the indication marks to be displayed in the interest mode and the indication mark other than the one of the indication marks to be displayed in the invisible mode, and when the piece of position information indicates a position not in the vicinity of any of the indication marks accumulated in the indication mark storing part, the display mode control part allows all the indication marks to be displayed in the non-interest mode.

9. The information processing system according to claim 1,
wherein the indication mark storing part accumulates the indication marks by dividing the indication marks into groups of one or a plurality of the indication marks, and
the display mode control part controls the display mode with respect to each of the groups.

10. The information processing system according to claim 1, further comprising an indication mark identifying part that identifies a shape of each of the indication marks accumulated in the indication mark storing part and classifies the indication marks into one or more mark types according to the shape,
wherein the display mode control part controls the display mode with respect to each of the mark types.

11. The information processing system according to claim 1, further comprising a material changing part that changes according to the indication mark displayed by the indication mark display part, a display of a portion of the material displayed by the material display part that corresponds to the indication mark.

12. A recording medium on which a program that allows a computer to perform processing is recorded, the computer being connected to a display apparatus and to an input apparatus, the processing comprising processes of:
displaying information regarding a material used for a presentation in the form of an image on the display apparatus;
inputting as an indication mark a sequence of consecutively inputted pieces of position information among information inputted from the input apparatus and accumulating the indication mark in a storing unit;
displaying the indication mark accumulated in the storing unit together with the material on the display apparatus based on one of display attributes that are accumulated beforehand in the storing unit and respectively represent at least two different display modes of the indication mark; and
controlling the display mode of the indication mark based on the information inputted from the input apparatus.
